(19) United States
(12) Patent Application Publication
(10) Pub. No.: US 2026/0336498 A1
(43) Pub. Date: Oct. 29, 2026

(54) MOBILE HIGH-DENSITY AUTOMATED STORAGE AND RETRIEVAL SYSTEM

(71) Applicant: CARNEGIE MELLON UNIVERSITY, Pittsburgh, PA (US)

(72) Inventors: GABRIEL GOLDMAN, Pittsburgh, PA (US); HERMAN HERMAN, Pittsburgh, PA (US)

(73) Assignee: CARNEGIE MELLON UNIVERSITY, Pittsburgh, PA (US)

(21) Appl. No.: 19/108,664

(22) PCT Filed: Nov. 16, 2023
(86) PCT No.: PCT/US2023/080091

§ 371 Date: Mar. 4, 2025

Related U.S. Application Data
(60) Provisional application No. 63/427,292, filed on Nov. 22, 2022.

(51) Int. Cl. B60P 1/00; B60P 3/00; B65G 1/137

(52) U.S. Cl. CPC B60P 1/00; B60P 3/007; B65G 1/1371; B65G 2203/0216

(57) ABSTRACT

Disclosed herein is a mobile high-density storage system comprising a storage structure deployed in a mobile container, for example, a tractor-trailer or a delivery van. The mobile storage structure optimizes the arrangement of totes within the structure while mobile such that the totes required for the next delivery are able to be easily accessed, for example, by moving the totes required for the next delivery to a location near and open end of the mobile container. In some embodiments, the mobile storage structure may interface with a storage structure deployed in a warehouse to automatically transfer totes from the mobile storage structure to the stationary storage structure.

### RELATED APPLICATIONS

This application is a national filing under 35 U.S.C. § 371 claiming the benefit and priority to International Patent Application No. PCT/US23/80091, filed Nov. 16, 2023 entitled “MOBILE HIGH-DENSITY AUTOMATED STORAGE AND RETRIEVAL SYSTEM”, which claims the benefit of U.S. Provisional Patent Application No. 63/427,292, filed Nov. 22, 2022, the contents of which are incorporated herein their entireties.

### BACKGROUND

Companies are pushing to maximize the storage density and efficiency of automated storage and retrieval systems (AS/RS) in their order fulfillment process. AS/RS systems use automated carriers that typically move either between or on top of structures that hold products or totes filled with products. In the case of systems where carriers move in between aisles of products and/or totes, there is a limit as to how dense the system can be in that the space required for the carrier movement reduces the overall potential storage density of the system.

Some systems maximize density by stacking products or totes vertically, which maximizes storage density, but has potentially lower efficiency when retrieving products or totes that are buried lower in the stacks. In one case, a gantry services a range of totes that are stacked on the floor, which minimizes infrastructure but ultimately has a limit on performance based on a limited number of gantry arms overlapping the same workspace. In another case, the system stacks totes vertically within a raised structure. Retrieval robots lift the totes from the top one-by-one. This results in a limit on performance to retrieve totes that are lower in the stack with each lift taking a longer amount of time proportional to the height of the tote stack or product being lifted.

### SUMMARY OF THE INVENTION

The embodiments described herein provide the capability for a highly dense storage solution while also providing a high level of performance, thereby improving both density and speed of retrieval over prior art systems. Instead of stacking the totes vertically (which has an inherent height limit due to the mechanical limit and the weight of the totes), the totes are arranged in horizontal layers of rows within a passive supporting structure. Unlike other systems, the totes are mechanically coupled to allow for a row of horizontally connected totes to be pulled and/or pushed together as a unit by pulling or pushing one or more totes on the end of a row, which will also pull or push all other totes within that same row that are connected to each other. This arrangement allows any totes within a row to be retrieved by repeatedly pulling and decoupling the outer tote or totes from the row until the right tote is retrieved. It also allows for the easy storage of totes. A tote could be stored in this AS/RS system simply by pushing a tote into a row that has an empty spot. As that tote is pushed into that row, it will automatically couple itself longitudinally when it comes into contact with the totes that are already in that row. This efficient storage approach could also be used to store totes that were removed from a row to access a tote-of-interest initially located on the interior of a row for retrieval.

The described embodiments store totes within a layered support structure. This structure supports the weight of all totes as well as providing rows within the structure in which totes can be stored. The totes are placed into the structure rows through a horizontal motion in a similar manner to other rack-based storage solutions. The novel storage structure allows for a high number of totes to be stored in a single row, whereas more standard rack structures allow for only a small number of totes or packages to be stored on a given shelf, because there is no efficient way to access totes that are located deep in the row. The described embodiments are able to retrieve totes from anywhere within a row upon request with a high level of performance in comparison to other high-density storage solutions. This is possible since all totes, no matter how deep they are located in the row, could be accessed just by pulling on the outside totes until the tote-of-interest is at the edge of the row. Pulling on the outer tote or totes will also pull all the other totes that are coupled, thereto allowing the tote-of-interest to be pulled toward the end of the row for retrieval.

Totes are pulled from or pushed into a row by a robotic carrier that can move from row-to-row within a single layer. In some embodiments, the carrier may be multiple rows in width and may be capable of pulling a tote from a row and shifting it to another row without vertical movement of the carrier. Carriers may work in pairs, with the carriers in the pair aligned at opposite ends of the rows, such that a tote expelled from a row by virtue of pushing a tote into the opposite end of the row is pushed onto a carrier and shifted on the carrier to another row, where it is pushed into the row.

In one embodiment disclosed herein, the storage structure is deployed in a building, for example, a warehouse from which goods are shipped to end-users. This embodiment is referred to herein as a stationary storage structure. In other embodiments, the described storage structure may be deployed in a mobile container. For example, the storage structure may be deployed in the trailer portion of a tractor-trailer, a railway car, a ship, an aircraft, a spacecraft, a shipping container, a delivery van, or any other mobile vehicle or structure. This embodiment is referred to herein as a mobile storage structure.

In some embodiments, the mobile storage structure may optimize the arrangement of totes within the structure while mobile such that the totes required for the next delivery are able to be easily accessed, for example, by moving the totes required for the next delivery to the rear of a tractor-trailer, near the back door. In some embodiments, the mobile storage structure may interface with a storage structure deployed in a warehouse to automatically transfer totes from the mobile storage structure to the stationary storage structure.

### BRIEF DESCRIPTION OF THE DRAWINGS

FIG. 1 is an illustration showing an exemplary configuration of the storage system of the present invention.

FIG. 2 shows more detail of a portion of the storage system shown in FIG. 1.

FIG. 3(a-l) are schematic illustrations of the process by which totes are shifted from a source row in the storage structure to a destination row in the storage structure.

FIG. 4 is a transparent illustration of a tote in accordance with the present invention.

FIG. 5 shows one embodiment of a tote coupling mechanism.

FIG. 6 is an illustration of one embodiment of the carrier.

FIG. 7 is an illustration of an exemplary embodiment of the in primary invention wherein the storage structure is deployed in a trailer.

FIG. 8 is an illustration of a second exemplary embodiment of the primary invention wherein the storage structure is deployed in a delivery van.

FIG. 9 is an illustration of a carrier showing multiple ways of loading and unloading a tote for intake into or output from the storage system or for transfer to another robotic carrier.

### DEFINITIONS

As used herein, the term “carrier” refers to a locally or remotely controlled robotic mechanism capable of moving about a tote support and storage structure in a vertical, horizontal or both directions and capable of accepting, carrying and discharging one or more totes from a source row to a destination row or from an intake of the storage structure to a row or to an output of the storage structure from a row.

As used herein, a “tote” refers to a structure capable of carrying goods for transport by a carrier from one location to another. The tote may be configured to be manipulated by a carrier for purposes of movement from a storage location to and from an exit or entry point of the storage system. The tote may be configured as a container or as a flat structure on which other containers may be placed.

As used herein, the term “storage structure” refers to a structure for storing totes and facilitating the placement and retrieval of totes within the storage structure by a carrier. The storage structure may be either stationary or mobile.

As used herein, the term “layer” refers to multiple rows for the storage and retrieval of totes. Layers can be oriented in a horizontal, vertical, or any orientation within the storage structure.

As used herein, a “row” is defined as a portion of a storage structure capable of storing a plurality of totes aligned longitudinally with each other and able to move in the longitudinal direction of the row. A row may be horizontal, vertical, or any orientation within the storage structure, but horizontal orientation is the preferred embodiment, because the force to pull a row of totes in the horizontal direction is significantly less than the force needed to lift the coupled totes in vertical direction.

### DETAILED DESCRIPTION

The embodiments described herein utilize multiple carriers that work in unison to manipulate totes or other stored product from a storage structure, to efficiently retrieve a particular tote or to store a tote. The process utilizes a system of coupled totes that allow for force to be shared within a row of totes in a direction aligned with the longitudinal axis of the row (in either positive or negative direction) but also allows for the totes to be decoupled by moving them in a direction orthogonal to the direction of the longitudinal axis of the row (either positive or negative direction). The novel technology can manipulate the totes or other products in both directions to move a target tote (and as a result, all totes coupled to the target tote) toward an end of the row where it may be decoupled from the row.

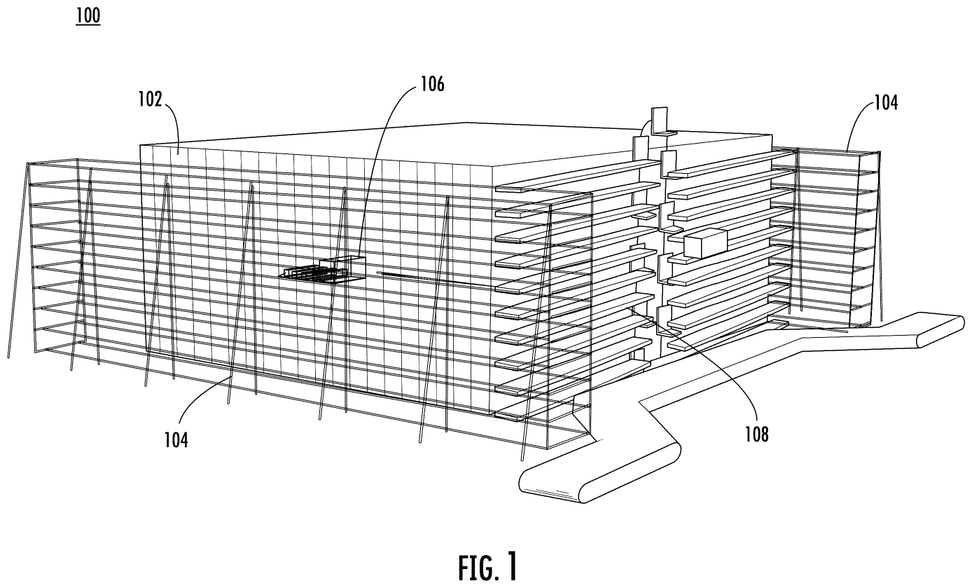

An exemplary storage structure 100 is depicted in FIG. 1. The structure consists of multiple layers of rows 102 containing totes, wherein the totes in each row 102 are coupled to each other to allow movement of the entire row by providing a pushing or pulling force on the tote at the end of the row. Carrier servicing area 104, disposed along opposite sides of the storage structure 100, guide one or more carriers 106 to the ends of rows 102 where the totes are to be manipulated. An intake/output structure 108 may be disposed anywhere within or outside of the structure 100 to facilitate the intake of totes into the system and the output of totes from the system. FIG. 1 shows only one possible embodiment of the system; many variations of the structure and configuration are possible and are considered to be within the scope of the invention.

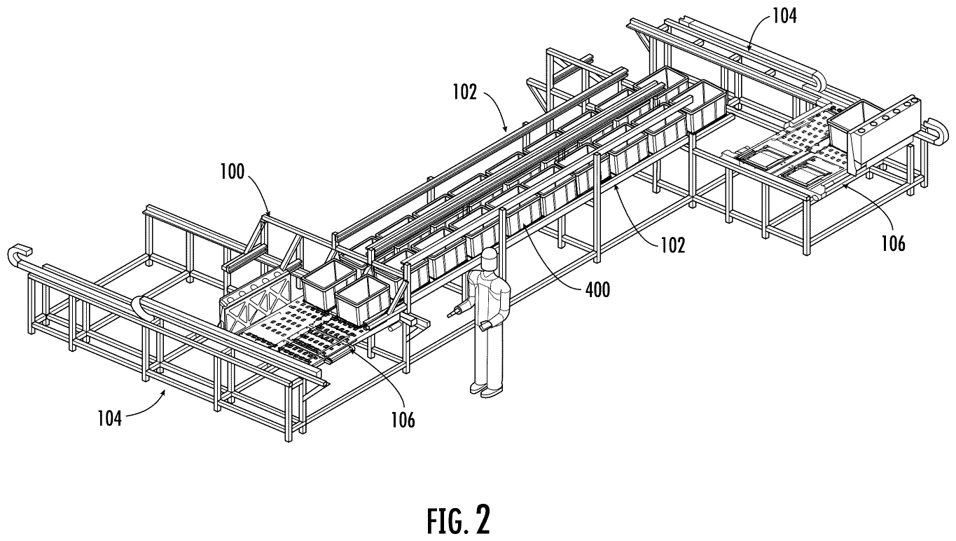

FIG. 2 shows a portion of storage structure 100. The portion shows two rows 102 containing only ten totes 400 per row. However, as would be realized by one of skill in the art, the length of each row 102, and therefore the number of totes 400 that may be stored in a row 102, may be limited only by the ability of the drives to provide the pushing or pulling force necessary to move the entire row of totes, including the weight of the goods contained in each tote. Carriers 106, disposed at either end of the rows 102 may move along carrier servicing area 104 such as to align with rows in the structure 100.

Carriers 106 have the ability to provide a pulling motion to a tote 400 at the end of a row 102 such as to move all of the totes in the row toward carrier 106. Carrier 106 may then shift the tote 400 at the end of row 102, which is now positioned on carrier 106, to a different position on carrier 106 aligned with a different row. The process of shifting the tote from a first position aligned with the source row to a second position aligned with the destination row automatically decouples the tote from the end of row 102. Carrier 106 also has the ability to push the tote into a destination row such as to cause it to couple with the tote at the end of the destination row.

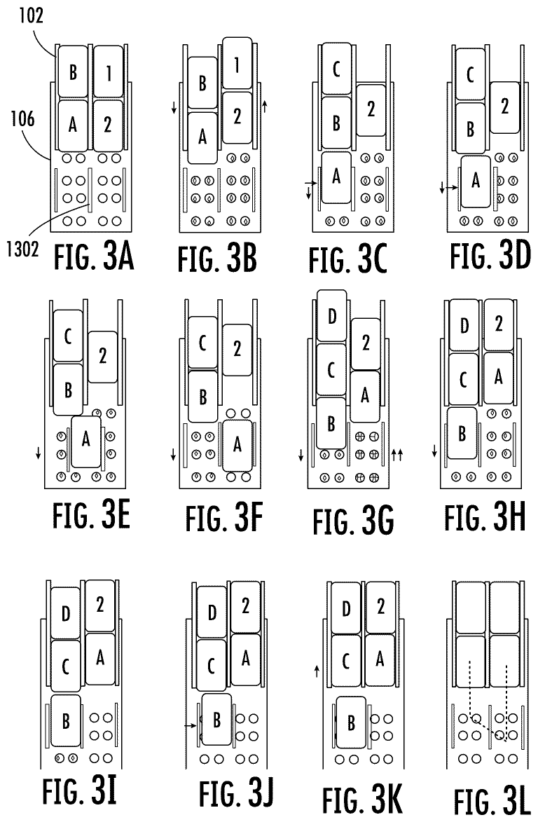

FIG. 3(a-l) are schematic illustrations of the process by which totes are shifted from one row (i.e., a source row) to another row (i.e., destination row) in the storage structure. The box labeled 106 in FIG. 3(a) represents carrier 106 in all of FIG. 3(a-l) and the lines between the totes represent rows 102. The series of illustrations will show the movement of totes labeled “A” and “B” from the source row on the left to the destination row on the right. FIG. 3(a) shows carrier 106 in position at the end of two rows of storage structure 102 and aligned with both the source and destination rose. A pulling force exerted on tote “A” causes the all of the totes in the source row to move in direction “X”. At the same time, or at a pre-determined time thereafter, a carrier on the opposite end of the rows 102 engages a tote at the end of the destination row and moves all of the totes in destination row in direction “Y”. FIG. 3(c) shows tote “A” clear of storage structure 102 and completely on the carrier. Once the tote is clear of the storage structure 102 the tote is free to be shifted from the source row to the destination row. Carrier 106 exerts a shifting force on the tote to align the tote with the destination row. In FIG. 3(d), tote “A” has begun its shift from the source row to the destination row. The process of shifting in a direction orthogonal to the row automatically decouples tote “A” from the source row, as will be discussed later. FIG. 3(e) shows tote “A” at the halfway point between the source row and the destination row. In FIG. 3(f), tote “A” is completely aligned with the destination row and carrier 106 exerts a pushing force on tote “A”, causing tote “A” to couple to tote “2” in the destination row. The actual path of the tote as it moves from the source row to the destination row shown in FIG. 3(l). Of particular interest is the diagonal motion of tote “A” as it moves from the source row to the destination row on the carrier 106. Also note, as shown in FIG. 3(f), tote “B” is almost out of the source row and positioned on carrier 106. As shown in FIG. 3(g), tote “B” enters the left side of carrier 106 as tote “A” is exiting carrier 106 and being moved into the destination row. FIG. 3(h-k) show the same processes as described above for moving tote “B” into the destination row.

### Tote Configuration

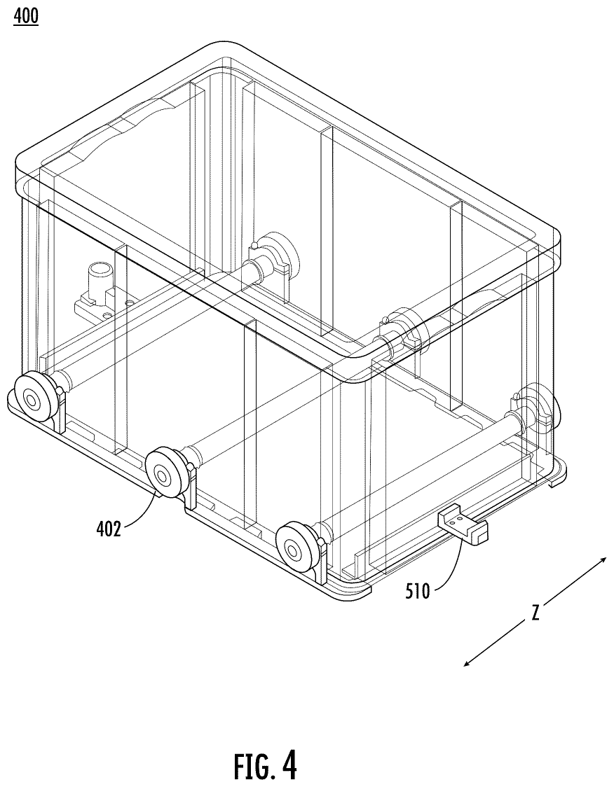

The configuration of totes 400 will now be discussed. A first embodiment of the tote is shown in FIG. 4, wherein the tote embodies a container structure 400 for accepting goods for storage. In an alternate embodiment of the invention, tote 400 may be configured as a flat platform which can accept goods or containers for goods stacked thereon.

As shown in FIG. 4, tote 400 is configured with a series of wheels 402 on opposite sides thereof to allow movement of the tote along a longitudinal axis of each row 102. In one embodiment, shown in FIG. 4, wheels 402 are mounted above the bottom surface of tote 400 and engage parallel tracks disposed on either side of each row 102. In one embodiment, the tracks may be “C-shaped” at support the wheels 402 in both the up and down directions. In another embodiment, not shown, wheels 402 may be disposed near the top surface of tote 400 and would engage the parallel tracks such that tote 400 would hang from the track. In such cases, the tote may be configured as, for example, a flat carrier having a mechanism to engage hanging goods such as clothing. In some embodiments, the wheels may be disposed not on the totes, but in the rows of storage structure 100, wherein the totes ride on the wheel in the rows. IN yet other embodiments, other means may be employed to minimize frictional between the totes and storage structure 100.

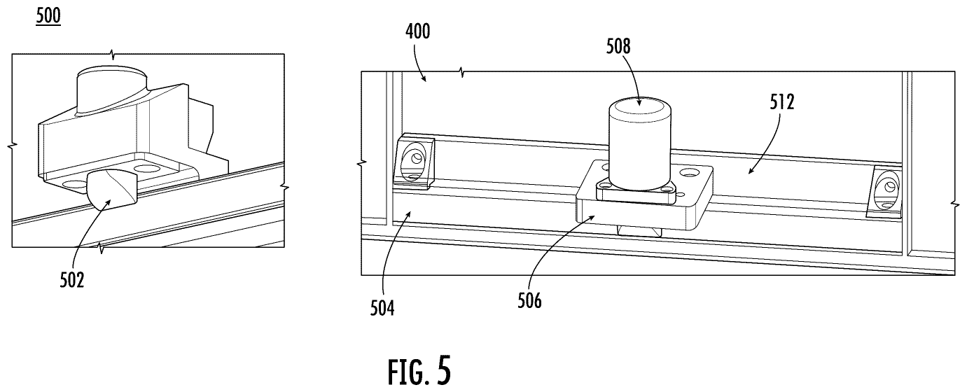

In a second aspect of the invention, totes 400 are configured with a coupling mechanism 500 that automatically engages as totes 400 are moved together. FIG. 5 shows one embodiment of the coupling mechanism. In this embodiment, a first portion of the coupling mechanism 500 comprises a spring-loaded latch 502 having an angled surface that pushes up when the spring-loaded latch 502 encounters a hook mechanism 510, shown in FIG. 4. In one embodiment, coupling mechanism 500 is securely attached to the body of tote 400 via a mounting plate 506 which is securely attached to support structure 504 which in turn is attached to the body of tote 400. Coupling mechanism 500 may include a dust cover 508 and the spacing may be adjusted utilizing a spacer 512 to reinforce the tote wall. In other embodiments of the tote, other configurations are possible. For example, the entire coupling mechanism support structure could be part of the molded plastic from which the tote is constructed.

De-coupling of totes 400 occurs when one tote is moved in a direction orthogonal to the longitudinal line of the row 102, that is, tote 400 is moved towards another row 102 in storage structure 100. As noted in FIG. 4, the edges of hook mechanism 510 are not closed (like the edge portion) such that movement of the tote in either direction indicated by the arrow “Z” will cause hook mechanism 510 to disengage from spring-loaded latch 502, thus decoupling the totes. Thus, as the tote moves from one row to another row, as shown in FIG. 3(d-e), the tote is automatically decoupled from the adjacent tote in the row. By the time the tote has reached position shown in FIG. 3(e), the tote is completely decoupled from the adjacent tote.

In one alternate embodiment, the totes may be configured with a coupling mechanism 500 and a hook mechanism 510 on each side of the tote, such that the totes may be bidirectionally inserted into and removed from rows 102.

As would be realized by one of skill in the art, the coupling mechanism 500 and hook mechanism 510 just described are only exemplary in nature, and that many other possible mechanisms for coupling and decoupling the totes are contemplated to be within the scope of the invention.

### Carrier Configuration

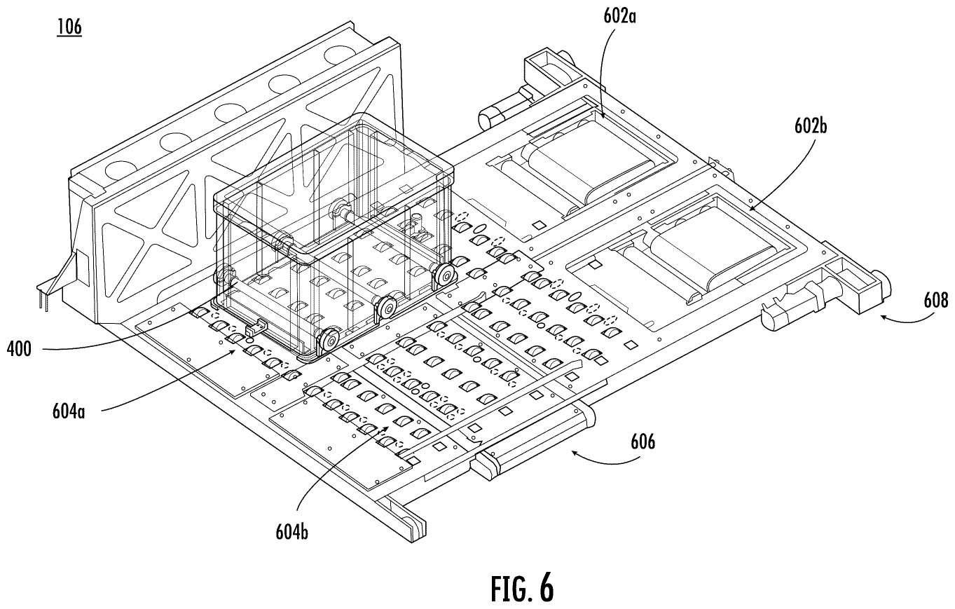

An exemplary configuration of carrier 106 is shown in FIG. 6. In this embodiment, carrier 106 is two rows wide, with one side spaced such as to receive a tote 400 from one row 102 and the other side spaced such as to deposit the tote 400 in an adjacent row 102. In other embodiments of the invention, the carriers may be multiple rows wide, with each row configured as shown in FIG. 6. In an extreme embodiment, carrier 106 may be configured to cover the entire length of the edge of storage structure 100. In yet another embodiment, carriers 106 may be configured to transfer a tote 400 from one carrier 106 to an adjacent carrier 106.

In some embodiments, carrier 106 may be provided with a carrier drive 608 capable of moving carrier 106 within carrier servicing area 104 to align carrier 106 with different rows 102 of storage structure 100. In some aspects of this embodiment, the carrier 106 may be limited to movement within one layer of storage structure 100. In other aspects of this embodiment, the carrier 106 may be configured with a drive mechanism capable of moving carrier 106 between layers of storage structure 100.

Carrier 106 may be provided, in various embodiments, with a plurality of sensors both for providing an identification of a tote 400 via, for example, a barcode mounted on the tote 400, and for sensing the position of a tote 400 on carrier 106.

As would be realized by one skill in the art, the intake/output structure 108 may be located at any position on the end of or within the storage structure 100.

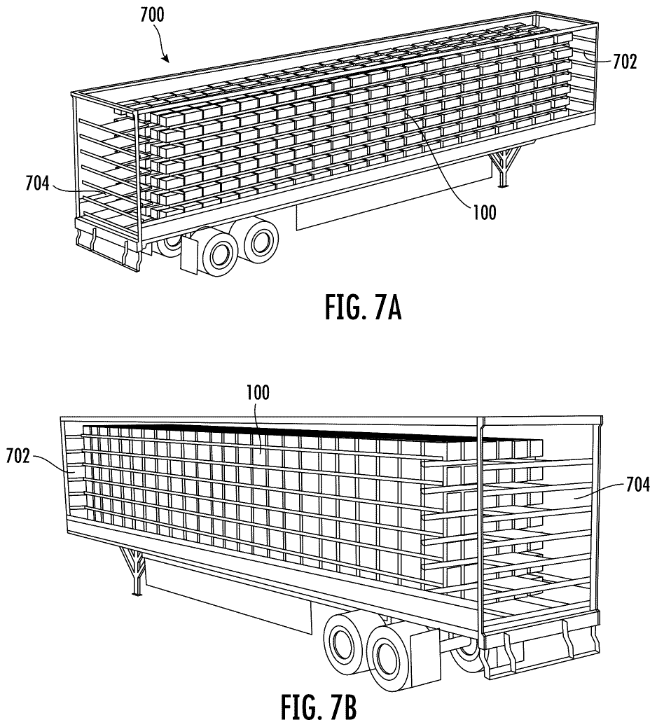

In a primary embodiment of the invention, a storage structure is deployed in a mobile container. In some embodiments, the storage structure may be storage structure 100 previously described herein and shown in FIGS. 1-6, or the storage structure may be of any other design. The primary invention will be explained in terms of an exemplary embodiment which is shown in FIG. 7(a-b), in which a storage structure is deployed in the trailer portion 700 of a tractor-trailer combo. The invention is not meant to be limited to the exemplary embodiment. In other embodiments, the storage structure may be deployed in any mobile container, for example, a railway car, a ship, a submersible vehicle, an aircraft, a spacecraft, a shipping container, a delivery van, or any other mobile vehicle or structure. In some embodiments, the mobile container may be temperature controlled.

In the embodiment shown in FIG. 7(a-b), a typical trailer 700 is shown having storage structure 100 deployed therein. In a typical 40-foot trailer 700, storage structure 100 may comprise 7 layers having 6 rows per layer and 25 totes per row, for a total capacity of 1050 totes. The number of totes accommodated in the mobile vehicle in this exemplary arrangement is dependent on the size of the totes. Other embodiments having varying tote sizes are possible and would change the number of totes that can be accommodated in the mobile vehicle. In other types of vehicles, other configurations of storage system 100 will be used having varying numbers of rows, layers and a varying number of totes per layer. It should be noted that area 702 of trailer 700 is left open to accommodate one or more robotic carriers 106 as previously described for shuffling totes within storage structure 100.

In various embodiments of the invention, carriers 106 deployed in area 702 trailer 700 may be of any configuration. For example, carriers 106 may be 2 rows wide and able to move laterally to service all rows per layer. In other embodiments, the carriers 106 may be the full width of the layer on which they are deployed to avoid having carrier 106 move back and forth within the layer. In one possible embodiment, each layer may be provided with one or more carriers 106 however, in other embodiments carriers may be used which are capable of moving not only within a row but between layers of storage structure 100. In other embodiments of the invention deployed in other types of mobile containers, the number and configuration of the carriers 106 may be varied to suit the particular application and configuration in which the storage structure 100 is deployed. As may be realized, it is necessary to be able to remove storage structure 100 from trailer 700 or otherwise provide access to carriers 106 (for example, by providing access doors) deployed in area 702 to provide servicing and maintenance to those carriers.

In various embodiments, area 704 of trailer 700 may be left open for the deployment of one or more carriers 106 in any configuration as described with respect to area 702. Carriers 106 deployed in area 704 will pair with carriers 106 deployed in area 702 to provide optimized shuffling of totes as described previously with respect to the stationary storage structure. In other embodiments, area 704 may be eliminated, in which case storage structure 100 may be expanded to the end of trailer 700 to accommodate more totes and may interface with a stationary storage structure or otherwise utilize carriers 106 which are deployed at a delivery location, as discussed below.

Trailer 700 may arrive at a destination where goods contained in the totes are to be delivered. In a first mode of operation, mobile storage system 100 may be programmed to deliver the required totes to the open end of trailer 700 after arriving at the destination such that they may be offloaded either automatically or manually. This mode of operation in the likely scenario when no carriers are deployed in are 704. In a second mode of operation, the totes contained within storage structure 100 may be shuffled while the mobile container is enroute to the next destination such that the totes required at the next destination are located nearest an open end of trailer 700.

In various embodiments, totes may be offloaded from trailer 700 or delivered to the open end of 700 where goods contained in the totes can be removed, in which case the totes may thereafter be returned to storage structure 100.

In a stationary storage structure 100, as described above, the storage structure may not be configured with an apparatus for inputting a tote into the storage structure or outputting a tote from the storage structure. In the mobile storage structure embodiment, the totes are simply be rearranged such that they are near an opening of the mobile container from which they can be either manually loaded or unloaded to or from the mobile storage structure or automatically loaded or unloaded to or from a stationary storage structure which may interface with the mobile storage structure to automatically unload the totes.

In one embodiment, one or more carriers 106 may be deployed within area 704. In this embodiment, totes required at the destination are moved onto the carriers 106 deployed in area 704. Once on carriers 106, the totes may be manually removed from trailer 700 or may stop on the carrier 106 temporarily as goods are removed from the tote, after which the tote is returned to storage structure 100. In other embodiments, totes may be automatically removed from trailer 700. This may be accomplished by moving the totes on to carriers 106 deployed in area 704 after which they are transferred to carriers at the destination using a carrier-to-carrier transfer.

Alternatively, the totes may be unloaded from carriers 106 directly onto a conveyor associated with et stationary storage structure. The carriers at the destination may or may not thereafter interface with a stationary storage structure. Alternatively, totes may be transferred from carriers 106 deployed in area 704 to an intake/output portion 108 of a stationary storage structure, for example to a conveyer belt via a gravity feed ramp.

In an alternate embodiment, area 704 is eliminated from the open end of trailer 700 and storage structure 100 is extended to the open end of trailer 700. In this embodiment, carriers deployed at the destination will interface with storage structure 100 deployed in trailer 700 and will pair with carriers 106 deployed in area 702 to deliver totes required destination to the open end of trailer 700. In various embodiments, all or just a portion of the totes contained in storage structure 100 may be delivered at any particular destination. It should be noted that, in this embodiment, it may not be possible to shuffle totes while trailer 700 is enroute to the next destination, as carriers 106 are only deployed on one end of storage structure 100, in area 702.

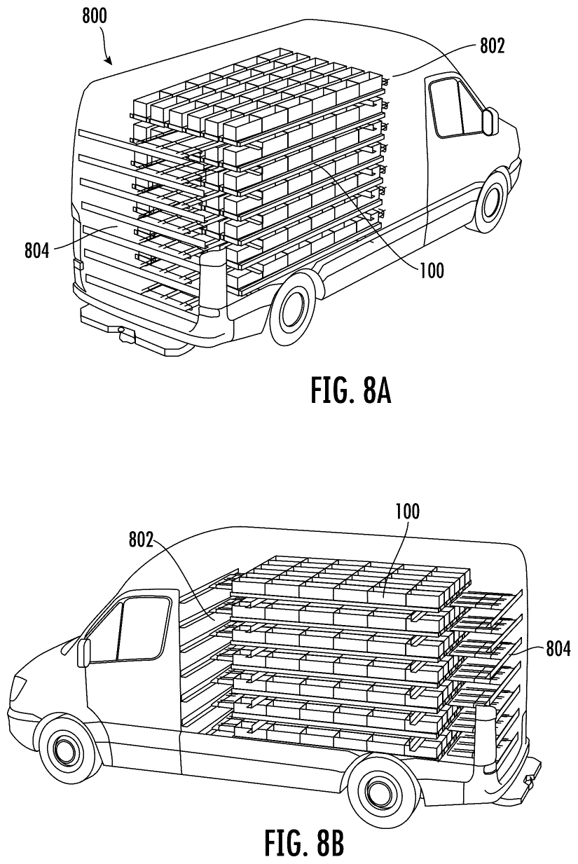

As previously discussed, storage structure 100 can be deployed in any type of mobile container. FIG. 8 (a-b) show an exemplary deployment in a delivery van 800. In a typical delivery van, storage structure 100 may comprise, for example, 7 layers having 6 rows per layer and 6 totes per row, for a total of 252 totes. Areas 802 and 804 reserved for the deployment of one or more carriers 106. In a preferred embodiment for delivery van 800, totes required for the next delivery are delivered to an opening within delivery van 800 while en route to the next destination, and the packages to be delivered can be manually unloaded from the tote by the delivery person. This embodiment eliminates the need for the delivery person to search for packages required for the next delivery when the delivery van 800 has reached the destination and also reduces the amount of time spent during a delivery by eliminating time for package retrieval from the van. It should be noted that it is not necessary that storage structure 100 be arranged within delivery van 800 such as to receive packages at the open rear end. It may also be possible to arrange storage structure 100 such as to deliver the totes containing packages to an opening in the side of delivery van 800. It should further be noted that when loading a van at a warehouse with packages to be delivered to various destinations, storage structure 100 deployed within delivery van 800 may be loaded manually or by interfacing, as previously described, with a stationary storage structure.

In extreme embodiments of the invention, storage structures may be nested. For example, a container ship may use a storage structure deployed on the ship to shuffle shipping containers (in lieu of totes) for delivery at the next port, while each shipping container may contain a storage structure 100

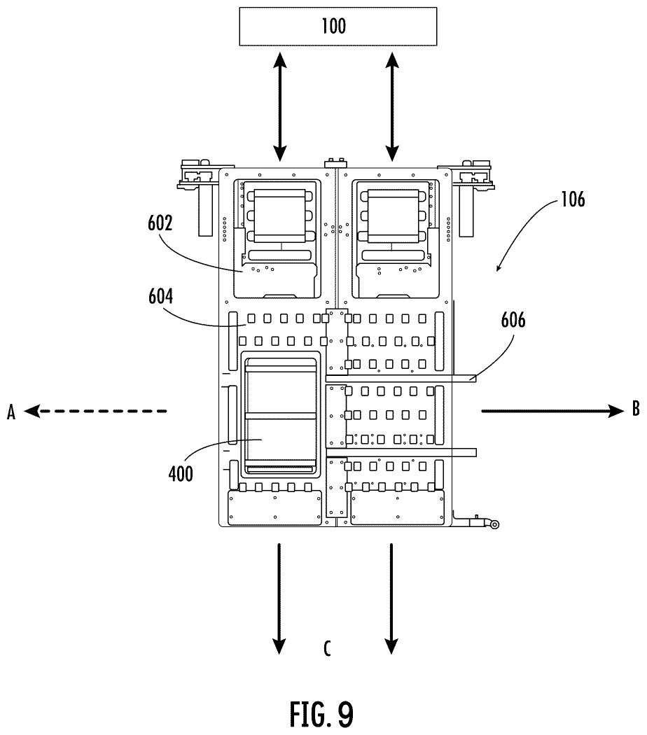

FIG. 9 shows a carrier 106 having the capability of moving totes off the carrier in any of directions “A”, “B” or “C”. This type of care 106 may be particularly useful when deployed in area 704 or 804 of tractor-trailer 700 or delivery van 800 respectively. This arrangement may be particularly useful when the carrier is used as an interface between a mobile storage structure and a stationary storage structure because it allows totes to be off-loaded from carrier 106 in direction “C”, to enable the automatic transfer of the totes to a second carrier which is part of the stationary storage structure.

The primary invention, a mobile storage structure, has been described using an exemplary storage structure 100 of the type disclosed herein, however, as would be realized by one of skill in the art, any design of a storage structure capable of delivering totes from the storage structure to an open-end of the mobile container are contemplated to be within the scope of the invention

The invention has been described in the context of specific embodiments, which are intended only as exemplars of the invention. As would be realized, many variations of the described embodiments are possible. For example, variations in the design, shape, size, location, function and operation of various components, including both software and hardware components, would still be considered to be within the scope of the invention, which is defined by the following claims.

1. A storage structure for deployment in a mobile container comprising:
one or more layers, each layer comprising a plurality of rows for storing a plurality of totes;
one or more robotic carriers for delivering one or more totes from the storage structure to an open end of the mobile container;
wherein the one or more robotic carriers comprise a first set of robotic characters deployed on an end of each layer opposite the open end of the mobile container.

2. (canceled)

3. The storage structure of claim 1 wherein the one or more robotic characters comprise a second set of robotic characters deployed on an end of each layer nearest an open end of the mobile container.

4. The storage structure of claim 1 wherein the one or more robotic carriers are mobile within a single layer of the storage structure.

5. The storage structure of claim 3 wherein the one or more robotic characters are mobile between layers of the storage structure.

6. The storage structure of claim 1 wherein each robotic carrier is multiple rows wide, each carrier being capable of:
removing a tote from a source row of the storage structure;
shifting the tote to a destination row the storage structure; and
pushing the tote into the destination row.

7. The storage structure of claim 6 wherein shifting a tote from a source row to a destination row comprises moving the tote in a direction orthogonal to a longitudinal line of the row from which the tote was removed and further wherein moving the tote in the orthogonal direction causes passive decoupling of the tote from other totes in the row.

8. The storage structure of claim 1 wherein the storage structure interfaces with a stationary storage structure or conveyance system outside of the mobile container.

9. The storage structure of claim 8 wherein one or more robotic carriers which are part of the stationary storage structure pair with robotic carriers in the first set of robotic carriers.

10. The storage structure of claim 8 wherein all or a portion of the totes stored in the storage structure are delivered to a destination.

11. The storage structure of claim 3 wherein the totes in the storage structure are shuffled within the storage system while en route to a destination such as to optimize a location of totes required at the destination.

12. The storage structure of claim 11 wherein the totes in the storage structure are shuffled based on items to be delivered at a next destination.

13. The storage structure of claim 3 wherein totes are delivered to a robotic carrier in the second set of robotic carriers.

14. The storage structure of claim 13 wherein totes are manually removed from the robotic carrier in the second set of robotic carriers.

15. The storage structure of claim 13 wherein totes are transferred from the robotic carrier in the second set of robotic carriers to a stationary storage structure.

16. The storage structure of claim 15 wherein the totes are transferred from a robotic carrier in the second set of robotic carriers to a robotic carrier which is part of the stationary storage structure.

17. The storage structure of claim 13 wherein the totes are transferred from the robotic carrier in the second set of robotic carriers to a stationary robotic carrier at the destination.

18. The storage structure of claim 17 wherein the totes or items stored within the totes are manually removed from the stationary robotic carrier at the destination.

19. The storage structure of claim 1 wherein all or a portion of the totes stored in the storage structure are delivered to an open-end of the mobile container wherein goods are removed from the totes and wherein thereafter, the totes are returned to the storage structure.

20. The storage structure of claim 1 wherein the mobile container is partially or fully temperature controlled.

21. The storage structure of claim 1 wherein the mobile container is selected from a group comprising a trailer portion of a tractor-trailer combo, a railway car, a ship, an aircraft, a spacecraft, a shipping container and a delivery van.
